(19) United States
(12) Patent Application Publication
(10) Pub. No.: US 2022/0083756 A1
(43) Pub. Date: Mar. 17, 2022

(54) SYSTEM AND METHOD FOR TRACKING SPECIFIC BATCHES OF AT LEAST ONE PROPRIETARY CHEMICAL COMPOSITION USED BY A PURCHASER AND/OR USER TO MANUFACTURE A FINISHED PRODUCT AT THE TIME AND LOCATION OF ITS INSTALLATION

(71) Applicants: Justin Reid Breiner, Stamford, CT (US); Juan Carlos Sanchez-Contreras, Norwalk, CT (US); Louis Cavallaro, Lutz, FL (US)

(72) Inventors: Justin Reid Breiner, Stamford, CT (US); Juan Carlos Sanchez-Contreras, Norwalk, CT (US); Louis Cavallaro, Lutz, FL (US)

(21) Appl. No.: 17/476,467

(22) Filed: Sep. 15, 2021

Related U.S. Application Data
(60) Provisional application No. 63/078,859, filed on Sep. 15, 2020.

(51) Int. Cl. G06K 7/14; G06K 19/06

(52) U.S. Cl. CPC G06K 7/1417; G06K 19/06037

(57) ABSTRACT

Specific drums of a B-side chemical component such as a proprietary resin for making spray foam products, where the final step(s) for manufacturing the end product is actually completed by a user installer that is unknown to the manufacturer, assigns unique QR codes for each drum that includes a batch number and the number of the drum in the batch. The QR codes are printed and affixed to the assigned drums and a mobile app is made available by which a user/installer can scan the QR code and be directly associated with the drum being used for manufacture/installation. The user/installer is incentivized through the mobile app to provide information regarding the installation, and rewarded to use the product again.

### CROSS-REFERENCE TO RELATED APPLICATIONS

This application claims the priority of U.S. Provisional Application No. 63/078,859 titled “METHOD FOR ASSOCIATING A PARTICULAR CHEMICAL DRUM WITH AN INSTALLER OF A CHEMICAL IN THE PARTICULAR CHEMICAL DRUM,” filed Sep. 15, 2020, the entire contents of which is incorporated herein by this reference.

### FIELD OF THE INVENTION

This invention relates generally to proprietary chemical compositions used in the manufacture of a finished product performed by a buyer and/or user at the time and place of the final product's installation, and more particularly to tracking specific batches of such proprietary chemical compositions to specific installations and installers.

### BACKGROUND OF THE INVENTION

The manufacture of most finished products is completed under the control of the manufacturer, even when some or even all of the steps of the manufacturing process are performed by subcontractors. In this scenario, the manufacturer is able to track batches (and even for some products each individual instance) of the final product sold for purposes of managing quality control of the manufacturing process, final inspection, as well as to knowing who purchased any instance of a finished product for purposes of warrantying the purchase against defects and rewarding customer loyalty. Tracking finished product enables a manufacturer to distinguish itself from other competitors in more ways than just price. It enables the manufacturer to build a reputation for high quality, product longevity, ease of use and installation, as well as general customer support and service.

Some finished products are not manufactured to completion under control of the manufacturer. This is true particularly where finished products are produced at the time and place of their installation. One such example is the installation of Spray Polyurethane Foam (SPF) into the walls and attics of buildings and houses to provide both heat and sound insulation. In this case, a proprietary chemical composition in the form of a resin (commonly referred to as a “B-side” component) is combined with a standard “A-side” activator chemical (e.g. pure methylene diphenyl iso-cyanate (MDI)), literally at the tip of the spraying mechanism. As a result, the final manufacture of the spray foam product results at the very time and place of installation. Final manufacture of the SPF product occurs at the time of installation because the nature of the product is such that its ease of installation lies in the ability to apply the product while it is still able to adhere to surfaces and fill in a customized space, including small gaps and fissures in the walls to provide a seal.

Because the purchasers of the proprietary resin component (B-side component) or their contracted installers are actually performing the final step in the manufacturing process, the seller of the proprietary resin product has no final control over how the final product is ultimately manufactured, or any specific knowledge of the location at which the final step of manufacture and as well as the installation took place.

Moreover, it may be difficult if not impossible to know the individuals who completed the manufacture of the finished product or its installation, let alone the various environmental factors that can influence the quality and reliability of the finished product. For example, in the case of the spray foam industry, the temperature of the A and B-side chemical components at the point where they are combined, as well as ambient conditions such temperature and humidity (among numerous others) can greatly affect adhesion and density of the foam, that in turn affects the ultimate R rating provided by the finished and installed product. In addition, much of the success of the final manufacture and installation can be greatly influenced by the training and experience of the user/sprayer performing the final step of manufacture and installation.

Without the direct visibility into, and the ability to close the loop on, issues that may incur in the final step of manufacture and installation, it makes it extremely difficult for manufacturers of proprietary B-side chemical compositions to distinguish their products based on the quality and reliability of the final product, as well as their reputation for customer service in addressing and correcting issues occurring as part of the final manufacturing step and concurrent installation. Thus, the only real basis for competing for sales is price, which drives down the suppliers' margins.

Finally, the user/sprayer is the one person who can provide the most influence on a purchaser of a B-side product for reasons other than price. They are the ones using the product and would be most directly influenced by recognizing the value in a supplier's customer support, as well as distinguish between products based upon ease of use and consistency in high quality outcomes.

Thus, it would be highly beneficial for B-side chemical manufacturers such as those manufacturing B-side spray foam resins, to be able to track the various factors affecting the final manufacture and installation of their products, including the identity of the individual user/installers who are completing the final manufacture and installation processes.

### SUMMARY OF THE INVENTION

In one aspect of the invention, a method for associating use of a particular B-side chemical drum containing a B-side chemical product with a particular installer of the B-side chemical product includes that for each of a plurality of chemical drums containing a B-side chemical product, a chemical supplier assigning a batch number to each chemical drum in the plurality of chemical drums, the batch number being identical for each of the plurality of chemical drums. And that for each of the plurality of chemical drums, the chemical supplier encodes information in a QR code to provide a unique QR code for each of the plurality of chemical drums, the information including the batch number and an identification number, the identification number being unique for each of the plurality of chemical drums. And that for each of the plurality of chemical drums, the chemical supplier assigns and affixes a unique QR code to a surface of the chemical drum. And before use of the B-side chemical product contained in the chemical drum, the installer scanning the unique QR code applied to the surface of the chemical drum. And the installer provides the unique QR code to a database server, the database server storing the unique QR code in associated relationship with the installer such that use of the B-side chemical product contained in the chemical drum is associated with the installer.

In a further embodiment, the installer acquires a second batch number from a second chemical drum containing an A-side chemical product that is to be used with the B-side chemical product and the installer provides the second batch number from the second chemical drum containing the A-side chemical product to the database server, the database server storing the second batch number in associated relationship with the QR code of the chemical drum containing the B-side chemical product, and in associated relationship with the installer.

In another embodiment, each of the plurality of chemical drums containing the B-side chemical product, the chemical supplier also encoding in the QR code at least one of: an expiration date of the B-side chemical product, a location of manufacture of the B-side chemical product, a name of a particular technician overseeing the manufacture of the B-side chemical product, a product-specific warning relating to the B-side chemical product, an application message for an installer of the B-side chemical product, and information regarding installation rewards for using the B-side chemical product.

In a further embodiment, the batch number also includes alpha-numeric characters.

In a still further embodiment, the installer scanning the unique QR code includes the installer scanning the unique QR code using a smart phone running an app configured to store the QR code.

In yet another embodiment, the installer provides the app with a second batch number from a second chemical drum containing an A-side chemical product that is to be used with the B-side chemical product, and the app is configured to store the second batch number and associate the second batch number with the QR code of the chemical drum containing the B-side chemical product.

In another embodiment, the app is configured to record the date and time of when the chemical drum containing the B-side chemical product and a second chemical drum containing an A-side chemical product were used and is configured to associate the date and time with the QR code of the chemical drum containing the B-side chemical product.

In a further embodiment, the installer providing the installer's contact information to the app, the app being configured to associate the installer's contact information with the QR code of the chemical drum containing the B-side chemical product.

In another embodiment, the installer's contact information includes installer email address, installer cell phone number, and installer identification number.

In a further embodiment, the installer scanning the QR code using the app results in changing a status associated with the QR code to “activated.”

In another embodiment, the chemical supplier encoding information in a QR code so as to provide a unique QR code for each of the plurality of chemical drums includes the app generating the unique QR code.

In a further embodiment, the app is configured to automatically acquire geo-location

In another embodiment, information and current weather condition information, and the app is configured to associate the geo-location information and current weather condition information with the QR code scanned by the installer.

In a further embodiment, the app is configured to record an assigned job number associated with the use of the chemical drum containing the B-side chemical product and a second chemical drum containing an A-side chemical product.

In a further embodiment, the app is configured to record assigned application parameters associated with the use of the chemical drum containing the B-side chemical product and a second chemical drum containing an A-side chemical product.

In another embodiment, the assigned application parameters include at least one of temperature settings, pressure settings, equipment used.

In a further embodiment, the chemical supplier applying a unique QR code to a surface of the chemical drum includes printing the QR code on a waterproof sticker and applying the waterproof sticker to the inside surface or the outside surface of the chemical drum.

In another embodiment, wherein the inside surface is the inside surface of a cap of the drum,

In a further embodiment, the outside surface is the top surface of the cap of the drum.

In another embodiment, the batch number assigned to each chemical drum in the plurality of chemical drums is associated with a manufacturer name of the B-side chemical product, a date of manufacture of the B-side chemical product, and a product name of the B-side chemical product

### BRIEF DESCRIPTION OF THE DRAWINGS

The invention will be more fully understood from the following detailed description, in conjunction with the following figures, wherein:

FIG. 1 is a system level block diagram representation of an embodiment of the system and method of the invention.

### DETAILED DESCRIPTION

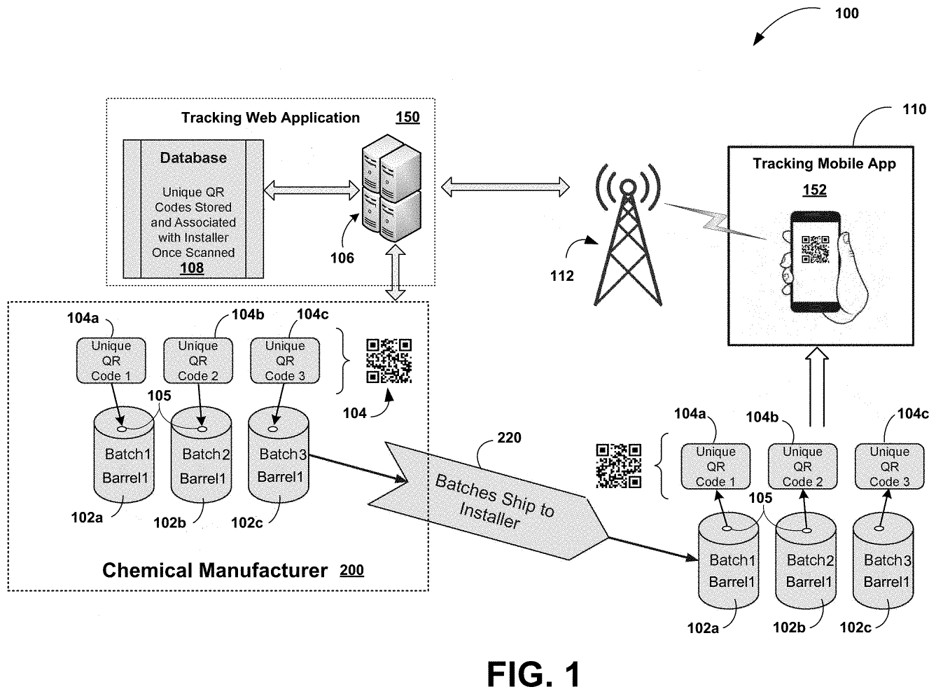

FIG. 1 is a system level diagram that illustrates an embodiment of the system 100 of the invention. A chemical supplier 200 manufactures a B-side chemical composition such as a resin that is combined with an A side activator chemical such as pure methylene diphenyl iso-cyanate (MDI) for manufacturing a spray foam product. The B-side component is produced in batches, and each batch is stored and transported in one or more standard chemical drums 120a-c.

A tracking web application software component 150 of a software system is executed by a server 106 to associate the final manufacturing step of a product using a particular drum of a particular batch of a proprietary B-side chemical component with the user/installer of that product who completes the manufacture of that product at the time of its installment. In an embodiment, the B-side chemical is a resin component is used to produce a spray foam product when combined during its installation by a sprayer/user with a standard activator A-side chemical as part of the installment process.

The tracker web app 150 can be accessed over a network such as the Internet by a manufacturer 200 of proprietary B-side chemical components such as spray foam resin to support the tracking of its drums to a particular installer/user of such product by entering the number of drums to be produced for a specific batch of the B-side chemical composition. Those of skill in the art will appreciate that the manufacturer would typically pay for access to the tracking web application 150 through the internet and would be given credentials by which to do so.

Based on the manufacturers batch information, web app 150 generates and assigns a unique QR code 104a-c to each drum of each new batch 102a-c of the B-side composition that is produced by the manufacturer 200. The generated QR codes 104 each embody the name of the manufacturer 200, the name of the B-side product, a unique batch number, and a unique identification number assigned to each drum used for that batch. The unique QR codes 104, along with the manufacturing information are then stored in database 108.

The generated and assigned QR codes 104 can then be printed by the manufacturer 200 and can be affixed to its assigned drum for each batch. In an embodiment, the QR code can be affixed to the underside of the bung cap 105 that is used to seal each resin (B-Side) drum. Each QR code 104 is unique and can only be used once. In this embodiment, the QR code 104 would have to be printed on, for example, waterproof stickers, because it may come in contact with the liquid chemical in the drum. The manufacturer affixes each printed QR code 104 at the time the drums are filled at the factory and the bung caps 105 are installed. Manufacturer 200 can also affix a promotional label to each B-side drum (preferably the top) to inform and promote the desirability of tracking the B-side chemical to user/sprayers and instructing them to scan the QR code to activate the tracking program. This opens up the opportunity for the manufacturer to engage directly with user/sprayer through the tracking program.

The manufacturer 200 can further pair each B-side drum with an A-side drum containing the activator chemical (typically a universal Isocyanate for spray foam) and can then sell and ship 220 the A and B-side drums together as a “system” or “set.” The A-side drums are not shown in FIG. 1 for simplicity. Regardless of whether the manufacturer 200 sells to a distributor, a spray contracting company or directly to a user/sprayer, the sets of A and B-side drums work their way through the supply chain ultimately to the user/sprayers. The A and B-side sets are loaded onto a spray foam truck (rig) where the user/sprayers will mix the two chemicals together through their sprayer to complete the final step in manufacturing to produce the final SPF Plastic insulation product while applying the reacting chemicals.

When the user/sprayer follows the instructions to participate in the tracking process, the user/sprayer will first download a tracking mobile application program 152 onto the user/sprayer's mobile processing device such as a smart phone. This can be accomplished by accessing a web app store through a cellular network 112 or a WIFI router, or by accessing the tracking web application 150 over the Internet. The tracking mobile app 152 display a graphical user interface through which the user/sprayer can request data to be uploaded to the tracking web application program 150.

Tracking mobile app 152 will request through the graphical user interface displayed on the user sprayer's PDA such as a smart phone that the user/sprayer establish a user profile that will include the sprayer's name, e-mail, telephone number, company name, a profile or username, and password. After unscrewing the bung cap 105 on the B-Side drum and exposing the QR code 104 sticker affixed to the bottom of the cap, the user/sprayers can use their phone's camera to scan the QR code 104. This scan will be uploaded to the web application 150 to verify that this QR code has not been scanned or used before. If successful, the particular user/sprayer is now linked to the particular drum of B-side chemical and the entry in database 108 for the scanned QR code 104 is updated to reflect this association.

The mobile app 152 can present additional graphic user interface screens by through which to solicit and encourage the associated user/sprayer to provide additional information pertinent to the final manufacture and installation of the finished product. This can include notations of ambient conditions such as temperature and humidity, along with the temperatures of the A and B side chemicals, as well as density measurements and even pictorial information. All of this information can then be uploaded to the web app 150 for storage in association with the batch and drum information in the database 108.

Further verification of the set or series can be accomplished through the web app 152 by requesting batch information for the A-side drum, which can be provided on the outside of the A-side drum. This will cause the mobile app 152 to request that the user/sprayer input a series of numbers from the A-side drum defining a batch number for the A-side chemical. When the web app 150 determines that the information embedded in the QR code 104 concerning the B-side of the set matches the set information stored in the database for the batch number uploaded from the A-side chemical drum, the QR code is activated for the B-side product and associated with the activating user/sprayer.

User/sprayers can be incentivized to participate in the tracking method of the invention in a number of ways. A Sprayer Incentive Program can be facilitated by the tracking system and method of the invention. Sprayer/user participation permits the manufacturer to reward those who actually influence the use of the B-side proprietary products, while providing the manufacturer a window into the final step of the manufacturing process for purposes of improving

Those of skill in the art will recognize that the tracking system and method of the invention of B-side chemical drums can be applied to any situation in which the manufacturer would benefit from a window into the final manufacturing steps of a finished product involving the B-side chemical, both for purposes of having a hand in the quality and reliability of the finished product, as well as the ability to have direct association with the user/installer for purposes of incentivizing disclosure of useful data as well as improving installer education and motivating continued use and promotion of the manufacturer's product.

What is claimed is:

1. A method for associating use of a particular B-side chemical drum containing a B-side chemical product with a particular installer of the B-side chemical product, the method comprising:
for each of a plurality of chemical drums containing a B-side chemical product, a chemical supplier assigning a batch number to each chemical drum in the plurality of chemical drums, the batch number being identical for each of the plurality of chemical drums;
for each of the plurality of chemical drums, the chemical supplier encoding information in a QR code to provide a unique QR code for each of the plurality of chemical drums, the information including the batch number and an identification number, the identification number being unique for each of the plurality of chemical drums;
for each of the plurality of chemical drums, the chemical supplier applying a unique QR code to a surface of the chemical drum;
before use of the B-side chemical product contained in the chemical drum, the installer scanning the unique QR code applied to the surface of the chemical drum; and
the installer providing the unique QR code to a database server, the database server storing the unique QR code in associated relationship with the installer such that use of the B-side chemical product contained in the chemical drum is associated with the installer.

2. The method of claim 1, further including:
the installer acquiring a second batch number from a second chemical drum containing an A-side chemical product that is to be used with the B-side chemical product; and
the installer providing the second batch number from the second chemical drum containing the A-side chemical product to the database server, the database server storing the second batch number in associated relationship with the QR code of the chemical drum containing the B-side chemical product, and in associated relationship with the installer.

3. The method of claim 1, wherein for each of the plurality of chemical drums containing the B-side chemical product, the chemical supplier also encoding in the QR code at least one of:
an expiration date of the B-side chemical product,
a location of manufacture of the B-side chemical product,
a name of a particular technician overseeing the manufacture of the B-side chemical product,
a product-specific warning relating to the B-side chemical product,
an application message for an installer of the B-side chemical product, and
information regarding installation rewards for using the B-side chemical product.

4. The method of claim 1, wherein the batch number also includes alpha-numeric characters.

5. The method of claim 1, wherein the installer scanning the unique QR code includes the installer scanning the unique QR code using a smart phone running an app configured to store the QR code.

6. The method of claim 5, wherein the installer provides the app with a second batch number from a second chemical drum containing an A-side chemical product that is to be used with the B-side chemical product, and the app is configured to store the second batch number and associate the second batch number with the QR code of the chemical drum containing the B-side chemical product.

7. The method of claim 5, wherein the app is configured to record the date and time of when the chemical drum containing the B-side chemical product and a second chemical drum containing an Aside chemical product were used and is configured to associate the date and time with the QR code of the chemical drum containing the B-side chemical product.

8. The method of claim 5, further including the installer providing the installer's contact information to the app, the app being configured to associate the installer's contact information with the QR code of the chemical drum containing the B-side chemical product.

9. The method of claim 8, wherein the installer's contact information includes installer email address, installer cell phone number, and installer identification number.

10. The method of claim 5, wherein the installer scanning the QR code using the app results in changing a status associated with the QR code to “activated.”

11. The method of claim 5, wherein the chemical supplier encoding information in a QR code so as to provide a unique QR code for each of the plurality of chemical drums includes the app generating the unique QR code.

12. The method of claim 5, wherein the app is configured to automatically acquire geo-location information and current weather condition information, and the app is configured to associate the geo-location information and current weather condition information with the QR code scanned by the installer.

13. The method of claim 5, wherein the app is configured to record an assigned job number associated with the use of the chemical drum containing the B-side chemical product and a second chemical drum containing an A-side chemical product.

14. The method of claim 5, wherein the app is configured to record assigned application parameters associated with the use of the chemical drum containing the B-side chemical product and a second chemical drum containing an A-side chemical product.

15. The method of claim 19, wherein the assigned application parameters include at least one of temperature settings, pressure settings, equipment used.

16. The method of claim 1, wherein the chemical supplier applying a unique QR code to a surface of the chemical drum includes printing the QR code on a waterproof sticker and applying the waterproof sticker to the inside surface or the outside surface of the chemical drum.

17. The method of claim 16, wherein the inside surface is the inside surface of a cap of the drum.

18. The method of claim 16, wherein the outside surface is the top surface of the cap of the drum.

19. The method of claim 16, wherein the outside surface is the outside of the drum.

20. The method of claim 1, wherein the batch number assigned to each chemical drum in the plurality of chemical drums is associated with:
a manufacturer name of the B-side chemical product;
a date of manufacture of the B-side chemical product; and
a product name of the B-side chemical product.
